(19) United States
(12) Patent Application Publication
(10) Pub. No.: US 2017/0104954 A1
(43) Pub. Date: Apr. 13, 2017

(54) SCREEN PROTECTOR

(71) Applicant: Esteban Tapia, San Diego, CA (US)

(72) Inventor: Esteban Tapia, San Diego, CA (US)

(21) Appl. No.: 14/881,389

(22) Filed: Oct. 13, 2015

(51) Int. Cl. H04N 5/64

(52) U.S. Cl. CPC H04N 5/64

(57) ABSTRACT

A device for protecting a television screen comprising having a mount wherein the mount is configured to engage the television; a cylinder configured to attach to the mount such that the cylinder will be positioned at the screen side of the television; and a protective material configured to coil around the cylinder, wherein the protective material is further configured to unravel over the television screen.

### BACKGROUND OF THE INVENTION

1. Field of Invention

This invention relates to protective devices for television screens and television covers.

2. Description of Related Art

Consumer electronics are very expensive and often fragile. Televisions are generally the most expensive item in this category of goods. Whether the television is a LED, LCD, DLP, conventional tube, or a further evolution of visual technology, they are prone to physical damage due to exposure to the elements or unwanted contact with foreign objects. Television screens are typically manufactured using glass, or plastic like material. When an object such as a remote control, gaming controller, or toy make contact with the screen they can easily cause irreparable damage rendering the expensive electronic worthless. Another common issue is exposure to water, dust, and other debris that can disrupt the internal electronic components. Furthermore, while a television may be a prized possession for some, they can also be unsightly.

Prior art consists of various rudimentary coverings for a television that are neither effective as protection nor aesthetically appealing. Current television covers are generally either of the “top-down” or “front-back” design. The top-down cover is essentially a large bag or sack that is placed upside-down over the television. Often the top-down cover will simply be a piece of material draped over the television. The front-back covers are typically wrapped around the television. Both designs require users to fumble with the application and in some instances require more than one person for use, which may result in damage to the expensive piece of electrical equipment they purport to protect. However, offer very little protection as they are made from a thin cloth or material that fails to do more than prevent dust accumulation. When not in use, these existing covers present further difficulties in storage due to them taking up space and providing no benefit while stored. The manufacturing of these covers has also failed in providing for anything that could be considered remotely visually appealing.

There is a need for an effective protective device that can prevent damage to television sets. Something is needed that can provide for a defense from the elements, other physical damage, and provide an aesthetically appealing option for television protection.

### SUMMARY OF THE INVENTION

The present invention provides a cost-effective and efficient [describes how it overcomes deficiencies in the prior art]

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a perspective view of the screen protector mounted to a television where the screen protector is rolled up, according to an embodiments of the present invention

FIG. 2 is a perspective view of the screen protector mounted to a television where the screen protector is pulled down to cover the television, according to an embodiment of the present invention.

### DETAILED DESCRIPTION OF PREFERRED EMBODIMENTS

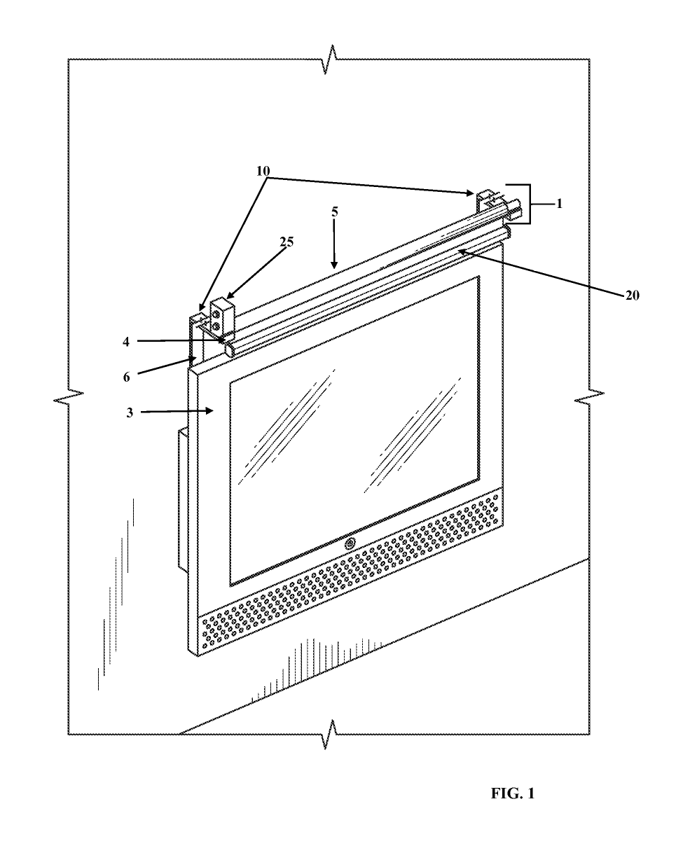

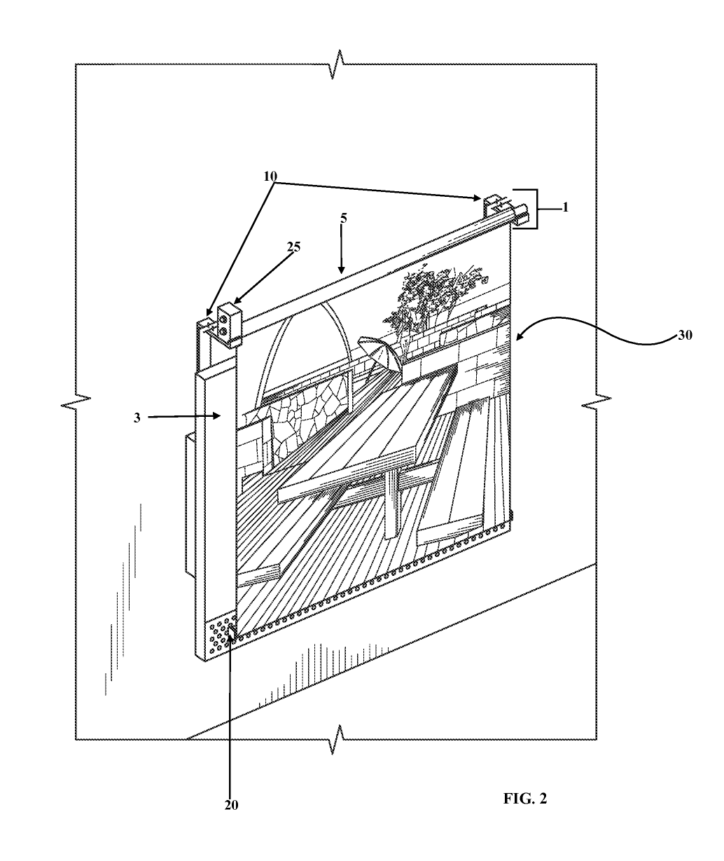

Preferred embodiments of the present invention and their advantages may be understood by referring to FIGS. 1-2) wherein like reference numerals refer to like elements.

Regarding FIG. 1, the screen protector has cylinder 5, at least one mount 15 that is capable of being attached to a television 3, a pull-down 20, and protective material 30. The cylinder 5 is affixed to the mount 10 such that the mount will not impede the rolling capabilities of the screen protector. A protective material 30 is coiled around the cylinder 5 such that when the screen protector 1 is not in use. When the screen protector 1 is in use, the protective material 30 is then pulled away from the cylinder 5 thereby unraveling the protective material 30 from its coiled position until a desired amount of protective material 30 has been unraveled to provide a physical barrier protecting the television 3.

In one embodiment of the present invention, the mount 10 comprises at least one hook. The hook is configured to fit over a side of the television 3. The hook may engage any side of the television 3. The hook is adapted with the necessary angles and curvature to effectively engaged the complimentary curvature and angles of the television 3.

In another embodiment of the present invention, the hook has a front end 4 and a rear end 6. The front end 4 of the hook is configures to engage the front corner of the television and the rear end 6 of the hook is configured to extend to the back edge of the television. The front end 4 of the hook is further adapted to connect to the cylinder 5 thereby retaining the cylinder 5 in position to the front of the television.

In another embodiment of the present invention, the mount 10 is an inverted trough that can be adapted to fit the length of the television such that the side of a television will matingly engage with the trough of the screen protector 1. For use on a flat-panel television such as an LCD or an LED display, the trough is expandable to fit over any length of the side of the television.

In one embodiment of the present invention, the screen protector 1 has a cylinder 5 that is configured to span the length of the side of the television to which it is mounted. The cylinder 5 has a first end and a second end. Both the first end and the second end of the cylinder are configured to attach to the mount 10 of the screen protector 1.

In one embodiment of the present invention, the cylinder 5 is configured to coil the protective material 30 around the cylinder 5 when the screen protector 1 is not in use. When in use, the protective material 30 is then unraveled from the cylinder 5 to cover the screen of the television.

In one embodiment of the present invention, the cylinder 5 has at least one gear and clutch mechanism to control and assist in the winding of the protective material 30 about the cylinder 5 as well as unraveling the protective material 30.

In one embodiment of the present invention, the gear and clutch mechanism is configured to have loaded tension maintained by a spring. The tension provides an assisted rotational force to assist in the operation through the coiling of the protective material around the cylinder 5.

In one embodiment of the present invention, the gear and clutch mechanism is driven by an electric motor. The electric motor is operated by a control module 25 having a plurality of buttons that provide the user with an option for coiling the protective material 30, or unraveling the protective material 30.

In one embodiment of the present invention, the control module 25 interacts with the electric motor remotely.

In one embodiment the protective material 30 is composed of a textile or other synthetic material such as vinyl, polyester, polyvinyl chloride (PVC), or acrylic. The protective material is configured to resist physical force of a contacting object.

In one embodiment of the present invention, the protective material 30 contains an image.

In one embodiment of the present invention, the protective material 30 is transparent thereby allowing for continued use of the television 3 while the screen protector 1 is in use.

In one embodiment of the present invention, images can be interchangeably displayed on the protective material 30. For example, the protective material may have a releasable affixation means that allows the protective material to accept and change images. In another embodiment the protective material 30 is constructed using a metallic material with magnetic properties such that images on a complementary magnetic sheet will engage with the protective material 30.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A device for protecting a television screen comprising:
a. a mount wherein the mount is configured to engage the television;
b. a cylinder configured to attach to the mount such that the cylinder will be positioned at the screen side of the television; and
c. A protective material configured to coil around the cylinder,
wherein the protective material is further configured to unravel over the television screen .

2. The device of claim 1, further comprising a pull-down configured to be pulled away from the cylinder wherein the pull-down is attached to an exposed end of the protective material.

3. The device of claim 1 wherein at least one gear and clutch mechanism is attached to an end of the cylinder.

4. The clutch and gear mechanism of claim 3 further configured to create a load whereby the load assists with operation of the screen protector.

5. The clutch and gear mechanism of claim 3 having an electric motor wherein the electric motor operates the clutch and gear mechanism.

6. The device of claim 1, wherein the protective material is transparent.

7. The device of claim 1, wherein the protective material depicts an image.

8. The device of claim 1, wherein one or more images can be interchangeably displayed on the protective material.
